(19) United States
(12) Patent Application Publication
(10) Pub. No.: US 2004/0239007 A1
(43) Pub. Date: Dec. 2, 2004

(54) Method for manufacturing resinous product

(75) Inventors: Tsuyoshi Arai, Kariya-city (JP); Yasunori Kawamoto, Toyota-city (JP); Hideki Okuda, Nagoya-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, AICHI-PREF. (JP)

(21) Appl. No.: 10/832,272

(22) Filed: Apr. 27, 2004

(30) Foreign Application Priority Data
Jun. 2, 2003 (JP) 2003-156968

(51) Int. Cl. B29C 65/16

(52) U.S. Cl. 264/482; 264/248

(57) ABSTRACT

A method for manufacturing a resinous product in which a second mold component 30 is fitted into an engagement hole 24 of a first mold component 20 includes a molding process for molding the laser beam-transparent first mold component 20 and the laser beam-absorbent second mold component 30, respectively, with resin, an engagement process for fitting the second mold component 30 into an engagement hole 24 formed in the first mold component 20 during the molding process to form an annular closed space 50 extending in the circumferential direction of the engagement hole 24 in the engagement boundary between the engagement hole 24 and the second mold component 30, and a welding process for irradiating the laser beam along a path L1 penetrating the second mold component 30 and reaching the first mold component 20 while passing through the closed space 50 so that the first and second mold components 20 and 30 are welded and fixed with each other.

### BACKGROUND OF THE INVENTION

1. Field of the Invention

The present invention relates to a method, for manufacturing a resinous product, in which a second mold component is fitted into an engagement hole of a first mold component.

2. Description of the Related Art

In the prior art, when a resinous product is manufactured by fitting a second mold component into an engagement hole of a first mold component, a method as illustrated in FIGS. 23A and 23B is used. In this method, initially, the first mold component 1 is molded from a laser beam-absorbent resin and the second mold component 2 is molded from a laser beam-transparent resin. Then, after the second mold component 2 has been fitted into an engagement hole 3 formed in the first mold component 1 when it is molded, the first and second mold components 1, 2 are welded together by a laser beam welding method disclosed in, for example, Japanese Unexamined Patent Publication No. 2001-71384. Concretely, a laser beam is irradiated along an irradiating path L from the second mold component 2 side to a fitting surface between the second mold component 2 and the engagement hole 3 to melt the first mold component 1. Then, the second mold component 2 is melted by the heat of the molten resin. Resinous molten materials from the respective mold components 1, 2 are mixed together. The resinous mixture is cooled and solidified to fix the molded components 1, 2 to each other.

However, the above-mentioned method has a drawback in that a clearance 4 as shown in FIG. 23B is formed in the boundary between the engagement hole 3 and the second mold component 2. Accordingly, the molten resin from the first mold component 1, melted by the irradiation of laser beam, flows out along the clearance 4. If the molten resin flows through the clearance 4 and swells out from an opening of the engagement hole 3, the molten resin is cooled and solidified to form a burr 6 as shown in FIG. 24A, which deteriorates the appearance of the resinous product. As an amount of resin becomes less in a welded portion 5 (see FIG. 23B) due to the flow-out of the molten resin, voids 7 as shown in FIG. 24B are generated after the residual resin in the welded portion 5 has been cooled and solidified. In the resinous product which is required to have sealability in the boundary between the engagement hole 3 and the second mold component 2, the sealability may be deteriorated by communication between a plurality of voids 7.

### SUMMARY OF THE INVENTION

An object of the present invention is to provide, in view of the above-mentioned problems, a method for manufacturing a resinous product free from burrs and voids.

According to the present invention, a second mold component is fitted into an engagement hole formed in a first mold component to form an annular closed space extending in the circumferential direction of the engagement hole in the engagement boundary between the engagement hole and the second mold component. The laser beam is irradiated to weld and fixed the first mold component and the second mold component to each other. At this time, the laser beam is irradiated along an irradiating path penetrating one of the first and second mold components having laser-beam transparency and reaching the other of the first and second mold components having the laser-beam absorbency while passing through the closed space in the engagement boundary. By the irradiation of laser beam along this path, molten resin flowing out from the other of the first and second mold components is sealed in the closed space in the engagement boundary, whereby it is possible to suppress the flowing-out of the molten resin along a clearance unavoidably formed in the engagement boundary. Accordingly, as the generation of burrs caused by molten resin swollen out from an opening of the engagement hole is suppressed, the appearance of the resinous product is favorably maintained. Also, as a sufficient amount of resin is maintained in a portion forming the closed space in which the welding occurs, the generation of voids is suppressed. Accordingly, it is possible to produce a resinous product excellent in sealability in the engagement boundary.

According to the present invention, two annular ribs formed with a distance between the two may be provided in an inner wall of the engagement hole, and the closed space may be formed by bringing an outer wall surface of the second mold component into press-contact with tip end surfaces of the ribs.

According to the present invention, two annular ribs formed with a distance between the two may be provided in an outer wall of the second mold component, and the closed space may be formed by bringing tip end surfaces of the ribs into press-contact with an inner wall surface of the engagement hole.

Thereby, it is possible to easily and assuredly form a closed space of a desired size.

According to the present invention, the laser beam may be irradiated while pushing the second mold component in the direction opposite to the projecting direction of the ribs.

According to the present invention, the laser beam may be irradiated while pushing the second mold component in the projecting direction of the ribs.

Thereby, even if the ribs begin to melt from the tip end side thereof due to the laser beam or heat of the molten resin, it is possible to bring the ribs into tight contact with the outer wall surface of the second mold component or the inner wall surface of the engagement hole. Thus, even if the ribs begin to melt from the tip end side thereof, it is possible to maintain the closed space as well as compress the molten resin sealed in the closed space. By the compression of the molten resin in the closed space, the effect for reducing the generation of voids is enhanced.

According to the present invention, an engagement hole having a larger hole section of a bottomed hole shape and a smaller hole section opened to a bottom wall surface of the larger hole section may be formed in the first mold component, and an engagement plate and an engagement rib projected from a plate surface of the engagement plate may be formed in the second mold component, and the closed space in the engagement boundary is formed by press-fitting the engagement rib into the smaller hole section and by bringing a portion of the plate surface of the engagement plate apart from the engagement rib into press-contact with a bottom wall surface of the larger hole section.

According to the present invention, the engagement hole of a bottomed hole shape may be formed in the first mold component. And, the engagement plate is formed in the second mold component during the molding process, and the closed space in the engagement boundary is formed by bringing a plate surface of the engagement plate into press-contact with the bottom wall surface of the engagement hole, and bringing a side surface of the engagement plate into press-contact with a portion of the side wall surface of the engagement hole apart from the bottom wall surface.

Thereby, the closed space is easily formed.

According to the present invention, the laser beam may be irradiated so that the laser beam passes through all areas of the closed space as seen in the extending direction of the closed space substantially at the same time. Thereby, as it is possible to shorten the time for welding the first and second mold components with each other, the production of the resinous product is enhanced.

According to the present invention, the laser beam may be irradiated so that a point in the closed space through which the laser beam passes is sequentially shifted in the extending direction of the closed space. Thereby, it is possible to use a common apparatus for irradiating the laser beam in the production of various kinds of resinous products.

A resinous product manufactured by the inventive method is free from the generation of burrs and voids. Thus, this resinous product is excellent in appearance and in sealabity at the engagement boundary.

The present invention may be more fully understood from the description of the preferred embodiments of the invention, as set forth below, together with the accompanying drawings.

### BRIEF DESCRIPTION OF THE DRAWINGS

In the drawings:

FIG. 1A is a sectional view showing a manufacturing method of a magnetic valve according to a first embodiment of the present invention, and FIG. 1B is an enlarged view of part B in FIG. 1A;

FIG. 2 is a perspective view of magnetic valve manufacture by the first embodiment of the present invention;

FIG. 3A is a sectional view of the magnetic valve manufactured by the first embodiment of the present invention, and FIG. 3B is an enlarged view of part B in FIG. 3A;

FIG. 4 is a flow chart showing the steps of a method for manufacturing the magnetic valve according to the first embodiment of the present invention;

FIG. 5A is a sectional view showing a manufacturing method of a magnetic valve according to the first embodiment of the present invention, and FIG. 5B is an enlarged view of part B in FIG. 5A;

FIG. 6 is a sectional view showing a manufacturing method of a magnetic valve according to the first embodiment of the present invention;

FIG. 7A is a sectional view showing a manufacturing method of a magnetic valve according to the first embodiment of the present invention, and FIG. 7B is an enlarged view of part B in FIG. 5A;

FIG. 8 is a perspective view showing a manufacturing method of a magnetic valve according to the first embodiment of the present invention;

FIG. 9A is a sectional view showing a manufacturing method of a magnetic valve according to a second embodiment of the present invention, and FIG. 9B is an enlarged view of part B in FIG. 9A;

FIG. 10A is a sectional view showing a manufacturing method of a magnetic valve according to the second embodiment of the present invention, and FIG. 10B is an enlarged view of part B in FIG. 10A;

FIG. 11A is a sectional view showing a manufacturing method of a magnetic valve according to the second embodiment of the present invention, and FIG. 11B is an enlarged view of part B in FIG. 11A;

FIG. 12A is a sectional view showing a manufacturing method of a magnetic valve according to a third embodiment of the present invention, and FIG. 12B is an enlarged view of part B in FIG. 12A;

FIG. 13A is a sectional view showing a manufacturing method of a magnetic valve according to the third embodiment of the present invention, and FIG. 13B is an enlarged view of part B in FIG. 13A;

FIG. 14A is a sectional view showing a manufacturing method of a magnetic valve according to the third embodiment of the present invention, and FIG. 14B is an enlarged view of part B in FIG. 14A;

FIG. 15 is a plan view showing a manufacturing method of a magnetic valve according to the third embodiment of the present invention;

FIG. 16 is a sectional view showing a manufacturing method of a magnetic valve according to a fourth embodiment of the present invention;

FIG. 17A is a sectional view showing a manufacturing method of a magnetic valve according to the fourth embodiment of the present invention, and FIG. 17B is an enlarged view of part B in FIG. 17A;

FIG. 18A is a sectional view showing a manufacturing method of a magnetic valve according to the fourth embodiment of the present invention, and FIG. 18B is an enlarged view of part B in FIG. 18A;

FIG. 19A is a sectional view showing a manufacturing method of a magnetic valve according to the fourth embodiment of the present invention, and FIG. 19B is an enlarged view of part B in FIG. 19A;

FIG. 20 is a sectional view showing a manufacturing method of a magnetic valve according to a fifth embodiment of the present invention;

FIG. 21A is a sectional view showing a manufacturing method of a magnetic valve according to the fifth embodiment of the present invention, and FIG. 21B is an enlarged view of part B in FIG. 21A;

FIG. 22A is a sectional view showing a manufacturing method of a magnetic valve according to the fifth embodiment of the present invention, and FIG. 22B is an enlarged view of part B in FIG. 22A;

FIG. 23A is a sectional view showing a conventional manufacturing method of a magnetic valve, and FIG. 23B is an enlarged view of part B in FIG. 23A; and

FIGS. 24A and 24B illustrate a resinous product manufactured by the conventional method, corresponding to FIG. 23B.

### DESCRIPTION OF THE PREFERRED EMBODIMENTS

A plurality of embodiments of the present invention are described with reference to the attached drawings.

(First Embodiment)

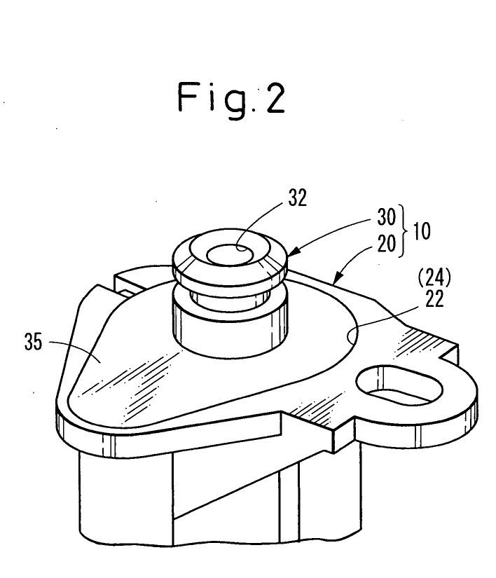

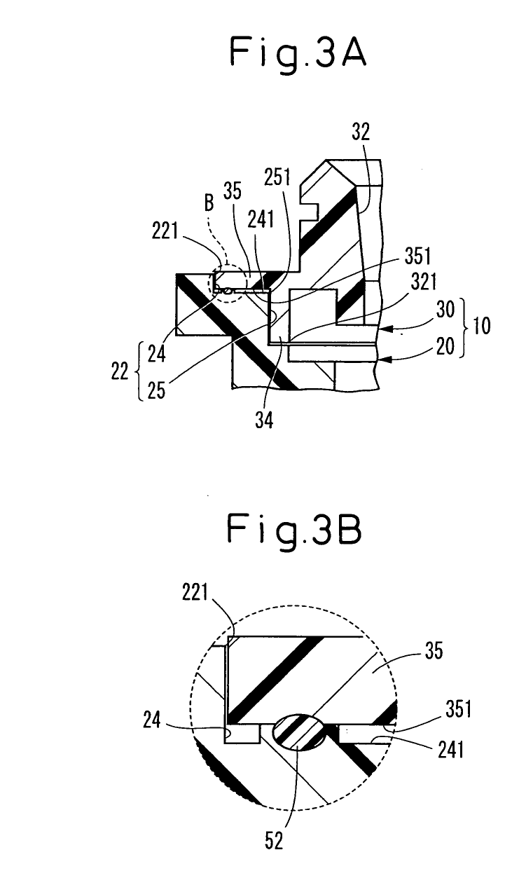

A magnetic valve which is a resinous product manufactured by a first embodiment of the present invention is shown in FIGS. 2, 3A and 3B. The magnetic valve 10 makes a valve member, accommodated in an inner hole 22 of a main body 20, reciprocate by feeding electric current to a coil embedded in the main body 20. The magnet valve 10 opens or closes a fluid passage formed by the respective inner holes 22, 32 of the main body 20 and a cap body 30 in response to the reciprocation of the valve member to control the fluid flow.

A structure of the magnetic valve 10 will be described.

The main body 20 as a first mold component and the cap body 30 as a second component are made of resin to form a cylinder, respectively. The inner hole 22 of the main body 20 has a larger hole section 24 and a smaller hole section 25 in this order as seen from an opening 221. The larger hole section 24 has a bottom wall and, in a central area of a surface 241 of the bottom wall, the smaller hole section 25 opens. The bottom wall surface 241 of the lager hole section 24 is an annular flat surface extending outward from the outer periphery of the opening 251 of the smaller hole section 25. The cap body 30 has an engagement rib 34 and an engagement plate 35 in this order as seen from an opening 321 of the inner hole 32. The engagement rib 34 is fitted with the smaller hole section 25 so that the inner hole 32 communicates with the inner hole 22. The engagement plate 35 is formed on a side opposite to the opening to have an annular shape, and fitted to the larger hole section 24. A plate surface 351 in an outer wall surface of the engagement plate 35 on the engagement rib side is an annular flat surface, and welded to the bottom wall surface 241 of the larger hole section 24 in the circumferential direction. By this welding, the engagement boundary between the engagement plate 35 and the larger hole section 24 is sealed.

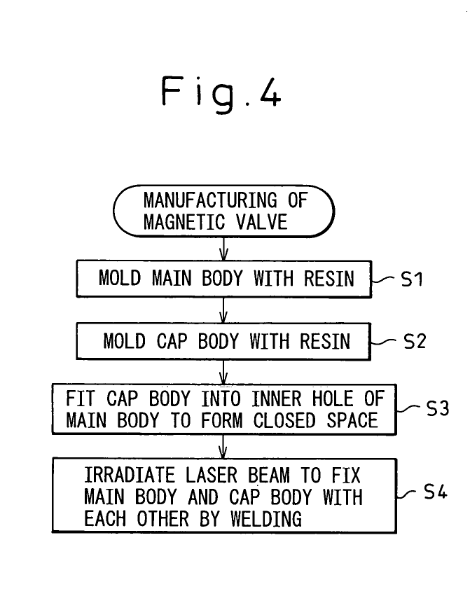

Next, a method for manufacturing the magnet valve 10 will be described with reference to a flow chard shown in FIG. 4.

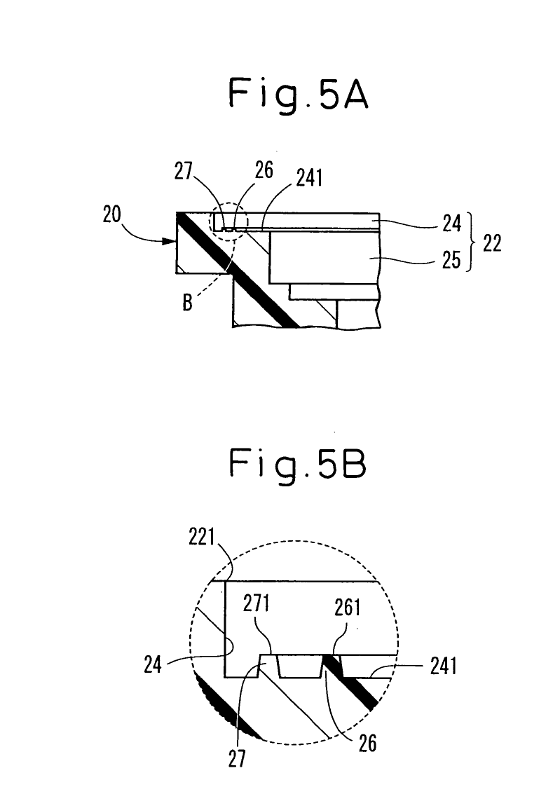

At step S1, the main body 20 having the laser-beam absorbency is molded with resin, as shown in FIGS. 5A and 5B, so that a coil is inserted therein. Thermoplastic resin is used so that the absorbency of the laser beam used becomes high and preferably the laser beam transparency is 5% or less. The thermoplastic resin used is, for example, polyamide, polypropylene, acrylonitrile-styrene copolymer and polybutylene terephthalate, or those blended with colorant such as carbon black or various additives.

At step 1 of this embodiment, as shown in FIGS. 5A and 5B, two ribs 26 and 27 projected from the bottom wall surface 241 of the larger hole section 24 in the main body 20 toward the opening 221 are formed together with the molding. The two ribs 26, 27 formed at a gap between the both annularly extend in the circumferential direction of the bottom wall surface 241. The respective ribs 26, 27 have flat tip end surfaces 261 and 271 parallel to the bottom wall surface 241 and are gradually thinner from the proximal end to the distal end.

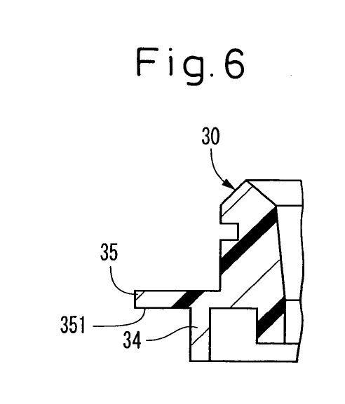

At step S2, the cap body 30 having the laser beam transparency is molded with resin as shown in FIG. 6. The cap body 30 is molded with thermoplastic resin so that the absorbency of the laser beam used becomes lower than that of the main body 20, preferably 25% or less. The thermoplastic resin used is, for example, polyamide, polypropylene, acrylonitrile-styrene copolymer and polybutylene terephthalate, or those blended with clarifier or various additives sufficiently low in absorbency of the laser beam are used.

Steps S1 and S2 correspond to the molding process.

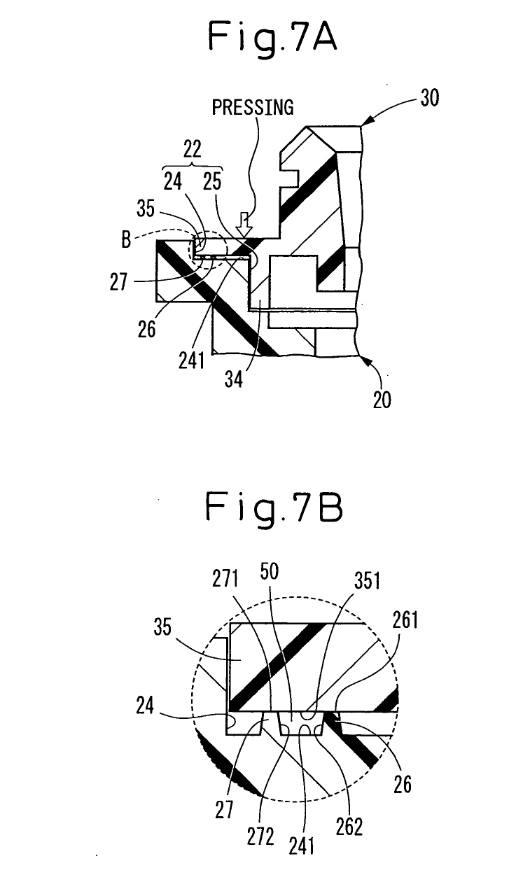

At step S3, after the valve member is inserted into the inner hole 22 of the main body 20, the engagement rib 34 and the engagement plate 35 of the cap body 30 are fitted into smaller hole section 25 and the larger hole section 24 of the inner hole 22 in the main body 20 as shown in FIG. 7. At this time, the engagement plate 35 is pressed to the bottom wall surface 241 of the larger hole section 24 so that the plate surface 351 of the engagement plate 35 is brought into press-contact with the tip end surfaces 261 and 271 of the respective ribs 26 and 27 of the larger hole section 24. Thereby, in the engagement boundary between the engagement plate 35 and the larger hole section 24, a closed space 50 encircled by opposite side surfaces 262 and 272 of the ribs 26 and 27, the bottom wall surface 241 of the larger hole section 24 and the plate surface 351 of the engagement plate 35 is formed and annularly extends in the circumferential direction of the larger hole section 24. Accordingly, step 3 corresponds to an engagement step, and at least, the larger hole section of the inner hole 22 corresponds to a engagement hole.

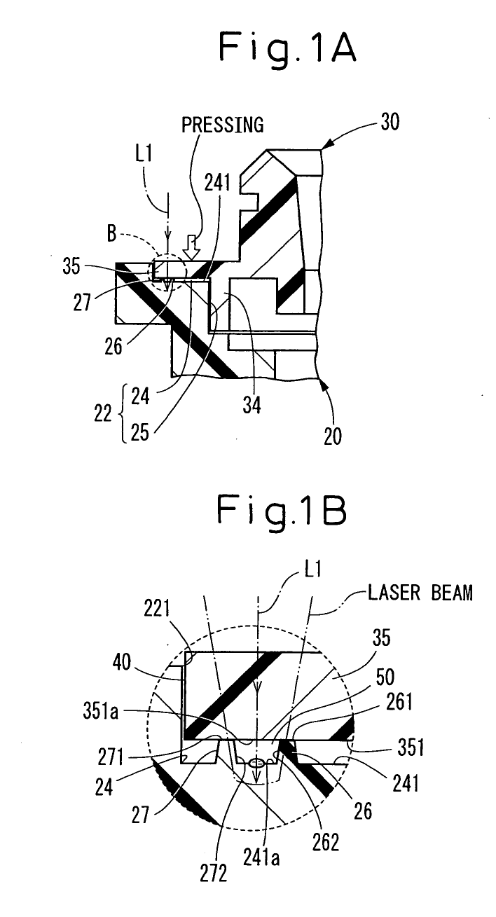

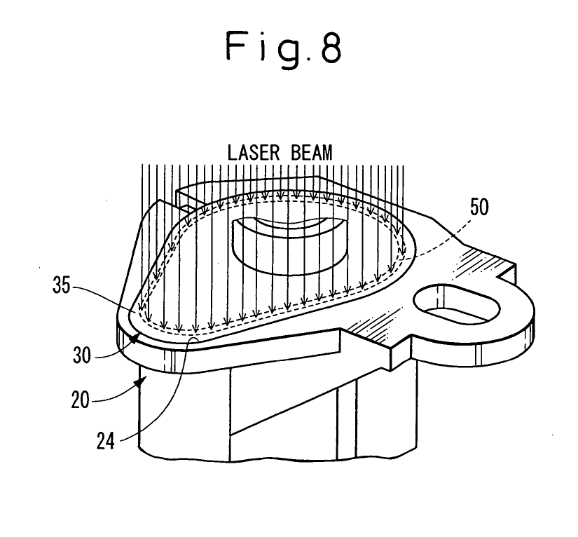

At step 4, as shown in FIGS. 1A and 1B, the laser beam is irradiated to the engagement boundary between the engagement plate 35 and the larger hole section 24 to weld the main body 20 to the cap body 30. At this time, the laser beam is irradiated from the cap body 30 side to the main body 20 in the direction opposite to the projecting direction of the ribs 26 and 27 along a path L1 passing through the closed space 50. Also, at this time, it is possible to shorten the welding time by irradiating the laser beam so that the laser beam passes simultaneously through almost all areas of the closed space 50 extending in the circumferential direction as schematically shown in FIG. 8. A laser generating the laser beam may be selected from, for example, a solid laser such as a glass laser, a ruby laser, a YAG laser or a titanium-sapphire laser, a gas laser such as a He-Ne laser, a CO₂ laser, a rare gas ion laser or an excimer laser, or a semiconductor laser and used at a suitable output power taking the resin component forming the main body 20 and the cap body 30 into consideration. In this regard, by dispersing the laser beam irradiated from the laser through a prism and regulating the irradiation direction with a mirror, it is possible to pass the laser beam substantially at the same time through all of the extended area of the closed space 50.

AS shown in FIG. 1A and 1B, the laser beam irradiated along the path L1 passes through the laser beam-transparent cap body 30 and is absorbed by a portion 241a exposed to the closed space 50 on the bottom wall surface 241 of the larger hole section 24 in the laser beam-absorbent main body 20. The portion 241a absorbing the laser beam is melted and the molten resin flows into the closed space 50 and is sealed therein. The molten resin sealed in the closed space 50 is brought into contact with a portion 351a of the plate surface 351 in the engagement plate 35 exposed to the closed space 50 and with the side surfaces 262 and 272 of the ribs 26 and 27 exposed to the closed space 50 to melt the resin forming the contact portions by the heat transfer. The molten resins of the main body 30 and the cap body 30 are mixed with each other, and are then cooled and solidified. As a result, as shown in FIG. 3B, the main body 20 and the cap body 30 are fixed to each other via the solidified resinous mixture 52.

The laser beam passes in the direction opposite to the projecting direction of the ribs 26, 27 by the above-mentioned design of the irradiation path L1. Accordingly, the laser beam-absorbent ribs 26 and 27 are liable to melt from the tip end surfaces 261 and 271, to which the laser beam is irradiated incident as schematically shown in FIG. 1B. At step S4 of this embodiment, as shown in FIG. 1A, the laser beam is irradiated while pushing the engagement plate 35 toward the bottom wall surface 241 of the larger hole section 24, i.e., opposite to the projecting direction of the ribs 26, 27. Thus, even if the ribs 26 and 27 are molten from the tip end surfaces 261 and 271, it is possible to bring the plate surface 351 of the engagement plate 35 into tight contact with the respective ribs 26, 27 to maintain the closed space 50, and to compress the molten resin sealed in the closed space 50. Also, it is possible to accurately confirm the welded state by controlling a sinking amount of the engagement plate 35 into the larger hole section 24 in correspondence to the molten amount of the tip end surfaces 261 and 271 in the ribs 26 and 27.

Step S4 corresponds to the welding process.

According to the manufacturing method described above, as the molten resin flowing out from the main body 20 irradiated with the laser beam is sealed in the closed space 50, it is possible to restrict the flowing-out of the molten resin along a clearance 40 created in the engagement boundary as shown in FIG. 1B. Thus, it is possible to mitigate the deterioration of the appearance due to burrs caused by the molten resin swollen out from the opening 221 of the larger hole section 24 in the main body 20. Also, as the amount of resin is sufficient at a position in the closed space 50 which becomes the welded portion and the molten resin in the closed space 50 is compressed by the pressure of the engagement plate 35, it is possible to sufficiently restrict the generation of voids in the solidified molten resin 52. Accordingly, a magnetic valve excellent in appearance and sealability in the engagement boundary is obtainable.

(Second Embodiment)

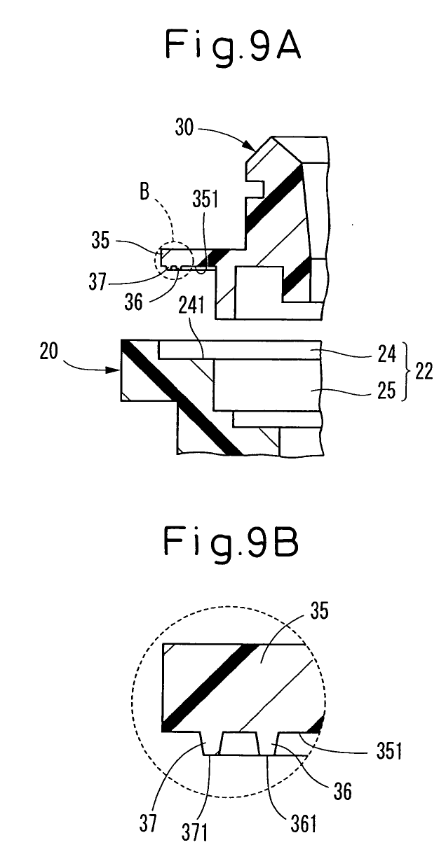

A second embodiment of the inventive method for manufacturing a magnetic valve 10 is illustrated in FIGS. 9A to 11B, wherein substantially the same elements as in the first embodiment are indicated by the same reference numerals.

As shown in FIGS. 9A and 9B, in the second embodiment of the inventive manufacturing method, the ribs 26 and 27 are not formed at step S1, and, instead, two ribs 36 and 37 projected from the plate surface 351 of the engagement plate 35 in the thickness direction are formed simultaneously with the molding of the cap body 30. The two ribs 36, 37 annularly extend at a gap between the both in the circumferential direction of the engagement 35. The ribs 36, 37 have flat tip end surfaces 361, 371, respectively, in parallel to the plate surface 351 and are gradually thinner from the proximal end to the tip end.

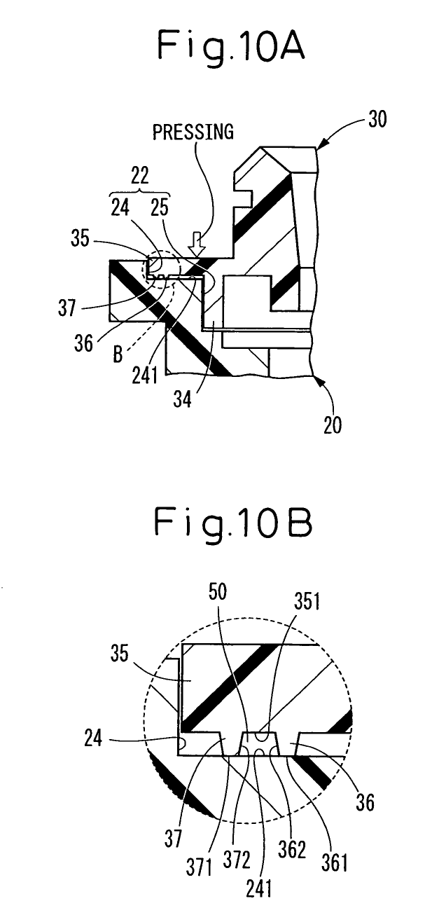

As shown in FIGS. 10A and 10B, at step S3, the engagement plate 35 is fitted into the larger hole section 24 and pushed toward the bottom wall surface 241 of the larger hole section 24, whereby the tip end surfaces 361, 371 of the respective ribs 36, 37 are pressed onto the bottom wall surface 241. Accordingly, in the engagement boundary between the engagement plate 35 and the larger hole section 24, the closed space 50 encircled by opposite side surfaces 362 and 372 of the ribs 36 and 37, the bottom wall surface 241 of the larger hole section 24 and the plate surface 351 of the engagement plate 35 annularly extends in the circumferential direction of the larger hole section 24.

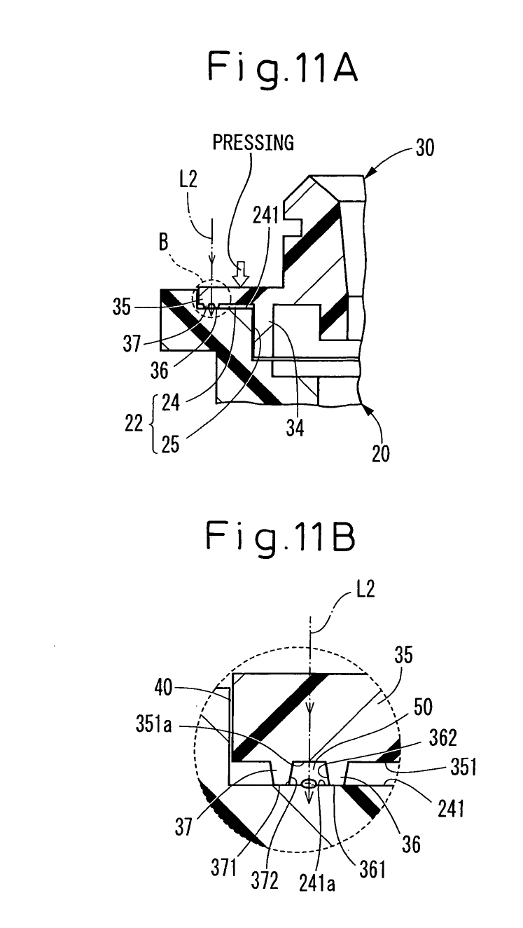

Further, as shown in FIGS. 11A and 11B, at step 4, the laser beam is irradiated along a path L2 extending from the cap body 30 side to the main body 20 through the closed space 50 in the projecting direction of the ribs 36 and 37. At this time, the laser beam is irradiated so that the laser beam passes all of the extended area of the closed space 50 substantially at the same time. The irradiated laser beam passes through the laser beam-transparent cap body 30 and is absorbed into a portion 241a on the bottom wall surface 241 of the laser beam-absorbent main body 20 exposed to the closed space 50. The portion 241a absorbing the laser beam is melted and the molten resin flows into the closed space 50 and is sealed therein. The molten resin sealed in the closed space 50 is brought into contact with the portion 351a on the plate surface 351 of the engagement plate 35 exposed to the closed space 50 and with the side surfaces 362 and 372 of the ribs 36 and 37 exposed to the closed surface 50 to melt resin forming the contact portions. In such a manner, resins flowing out from the main body 20 and the cap body 30 are mixed with each other, which mixture is cooled and solidified, whereby the main body 20 and the cap body 30 are fixed to each other via the solidified resin mixture.

The ribs 36 and 37 are liable to melt from the tip end surfaces 361 and 371 brought in contact with the bottom wall surface 241 due to heat of the resin flowing out from the portion 241a on the bottom wall surface 241. Accordingly, at step S4 in the second embodiment, the laser beam is irradiated while pushing the engagement plate 35 toward the bottom wall surface 241 of the large hole section 24, i.e., in the projecting direction of the ribs 36 and 37, as shown in FIG. 11A. Thereby, even if the ribs 36 and 37 are molten from the tip end surfaces 361 and 371, it is possible to bring the plate surface 351 of the engagement plate 35 into tight contact with the respective ribs 36, 37 to maintain the closed space 50, and to compress the molten resin sealed in the closed space 50. Also, it is possible to accurately confirm the welded state by controlling a sinking amount of the engagement plate 35 into the larger hole section 24 in correspondence to the molten amount of the tip end surfaces 361 and 371 in the ribs 36 and 37.

According to the inventive method of the second embodiment described above, as the molten resin flowing out from the main body 20 by the irradiation of laser beam is sealed in the closed space 50, it is possible to restrict the generation of burrs caused by the molten resin flowing out along the clearance 40 (see FIG. 11B) in the engagement boundary. Also, as the molten resin sealed in the closed space 50 is compressed by the pressure of the engagement plate 35, the generation of voids is significantly reduced.

(Third Embodiment)

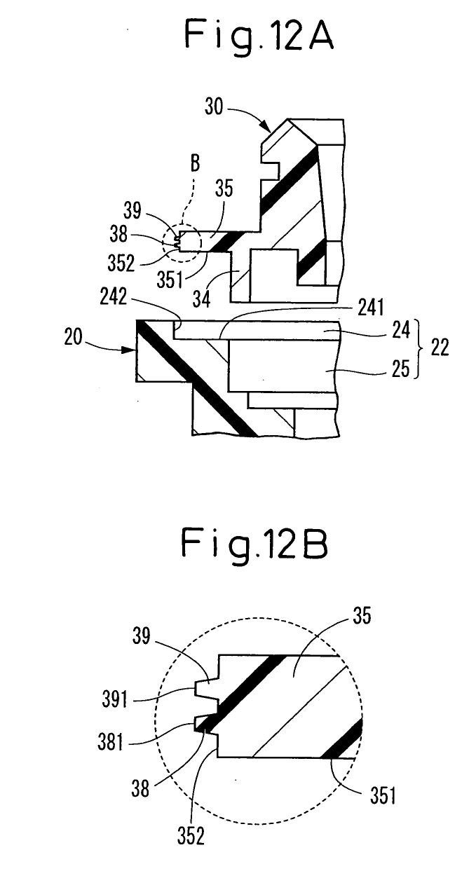

A third embodiment of the inventive method for manufacturing a magnetic valve 10 is illustrated in FIGS. 12A to 15, wherein substantially the same elements as in the first embodiment are indicated by the same reference numerals.

In the third embodiment, the laser beam-transparent main body 20 is molded with resin at step S1, and the laser beam-absorbent cap body 30 is molded with resin at step S2.

As shown in FIGS. 12A and 12B, the ribs 26 and 27 are not formed at step S1, and instead, two ribs 38 and 39 projected outward from a side surface 352 of an outer wall surface of the engagement plate 35 are formed simultaneously with the molding of the cap body 30 at step S2. The two ribs 38 and 39 annularly extend in the circumferential direction at a gap between the both. The respective ribs 38 and 39 have curved tip end surfaces 381 and 391 in conformity with a side wall surface 242 of an inner wall surface in the larger hole section 24 and are gradually thinner from the proximal end to the distal end.

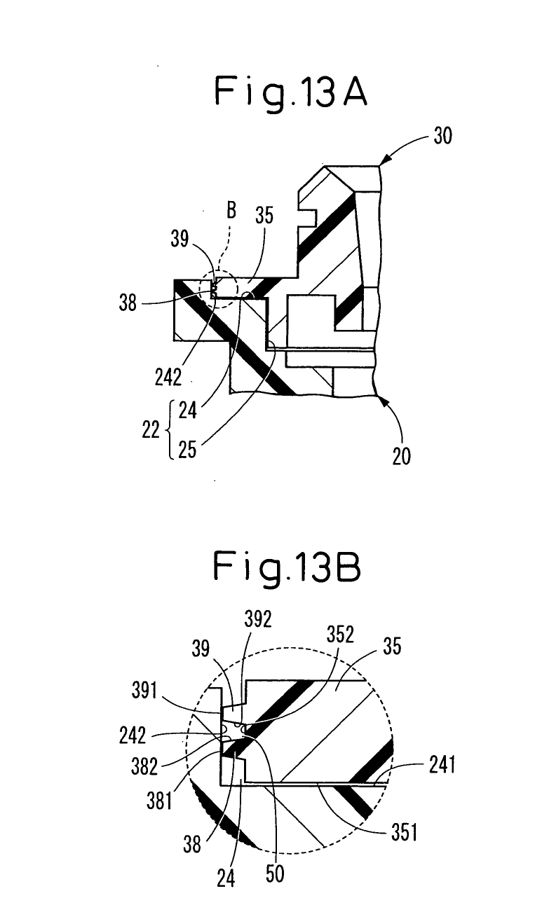

Further, as shown in FIGS. 13A and 13B, at step S3, the tip end surfaces 381 and 391 of the engagement plate 35 are brought into press-contact with the side wall surface 242 by fitting the engagement plate 35 into the larger hole section 24. Thereby, the closed space 50 encircled by opposite side surfaces 382 and 392 of the ribs 38 and 39 and the side wall surface 242 of the larger hole section 24 annularly extends in the circumferential direction of the larger hole section 24.

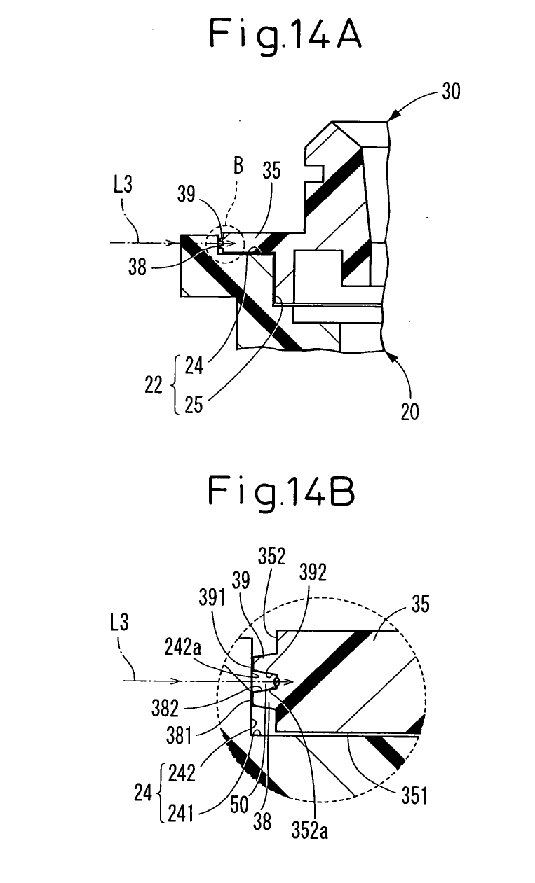

Also, as shown in FIGS. 14A and 14B, at step 4, the laser beam is irradiated from the main body 20 side along a path L3 extending opposite to the projecting direction of the ribs 38 and 39 through the closed space 50 to the engagement plate 35. At this time, as schematically shown in FIG. 15, a point in the closed space 50 through which the laser beam passes is sequentially shifted in the extending direction of the closed space 50, so that all of the circumferential areas in the engagement boundary are passed by the laser beam.

As shown in FIGS. 14A and 14B, the irradiated laser beam passes through the laser beam-transparent main body 20 and is absorbed in a portion 352a on the side surface 352 of the laser beam-absorbent engagement plate 35 exposed to the closed space 50. The portion 352a absorbing the laser beam is molted, and the molten resin flows into the closed space 50 and is sealed therein. The molten resin sealed in the closed space 50 is brought into contact with the side surfaces 382 and 392 exposed to the closed space 50, whereby resin forming the contact portion is molten. In such a manner, resins flowing out from the main body 20 and the cap body 30 are mixed to each other, which is then cooled and solidified. As a result, the main body 20 and the cap body 30 are fixed to each other via the solidified resinous mixture.

According to the inventive method of the third embodiment described above, as the molten resin flowing out from the cap body 30 irradiated with laser beam is sealed in the closed space 50, it is possible to restrict the generation of burrs caused by the flowing-out resin.

(Fourth Embodiment)

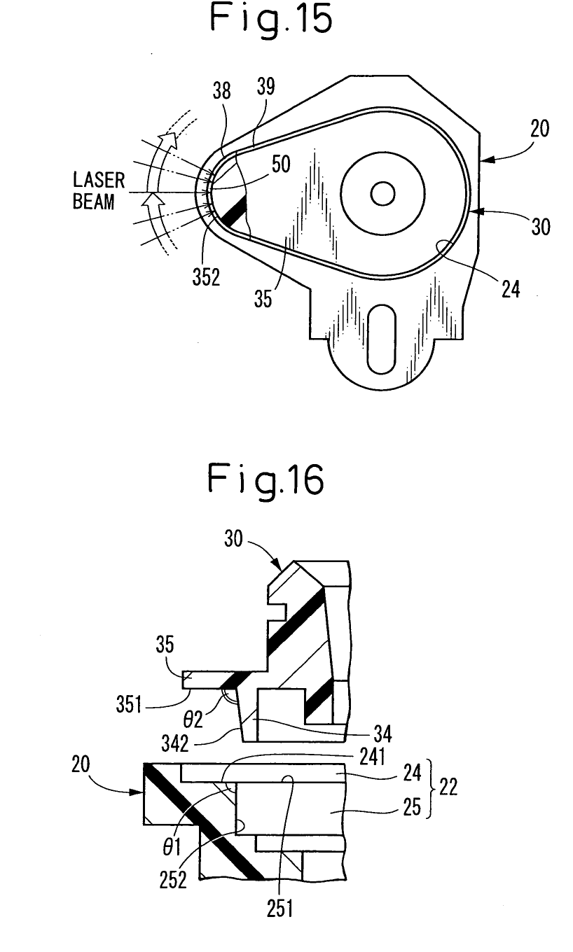

A fourth embodiment of the inventive method for manufacturing a magnetic valve 10 is illustrated in FIGS. 16 to 19B, wherein substantially the same elements as in the first embodiment are indicated by the same reference numerals.

As shown in FIG. 16, at step S1 of the manufacturing method according to the fourth embodiment, no ribs 26 and 27 are formed. Instead, at step S1, the main body 20 is molded so that a supplementary angle θ1 becomes approximately a right angle, which angle is defined by the bottom wall surface 241 and side wall surface 252 of the smaller hole section 25 in FIG. 16, for example, in the cross-section taken along a plane orthogonal to the bottom wall surface 241 of the larger hole section 24. Further at step S2, the cap body 30 is molded so that an angle θ2 becomes obtuse, which angle is defined by the plate surface 351 and the side surface 342 of the engagement rib 34 in FIG. 16, for example, in the cross-section taken along a plane orthogonal to the plate surface 351 of the engagement plate 35. By such determination of the angles θ1 and θ2, a proximal end portion of the engagement rib 34 closer to the boundary of the engagement plate 35 becomes larger than the opening 251 of the smaller hole section 25.

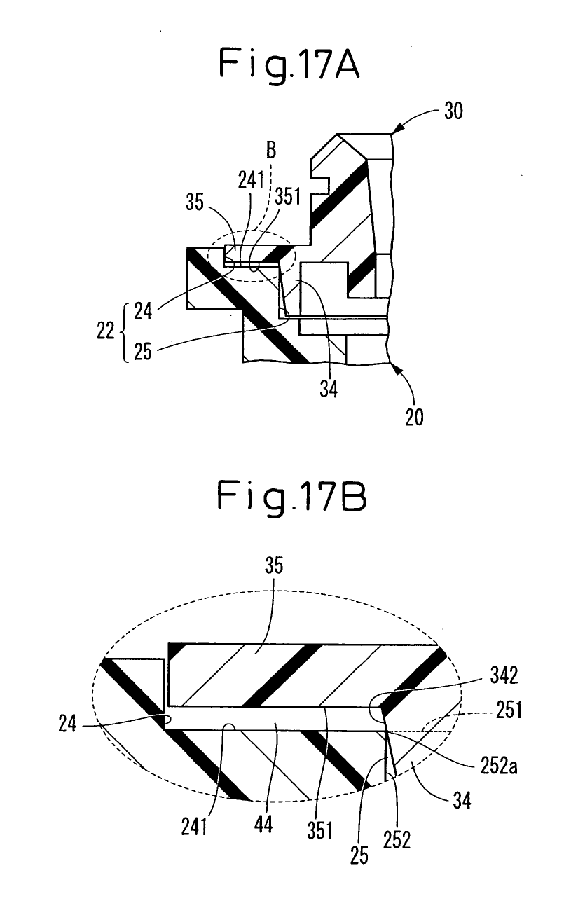

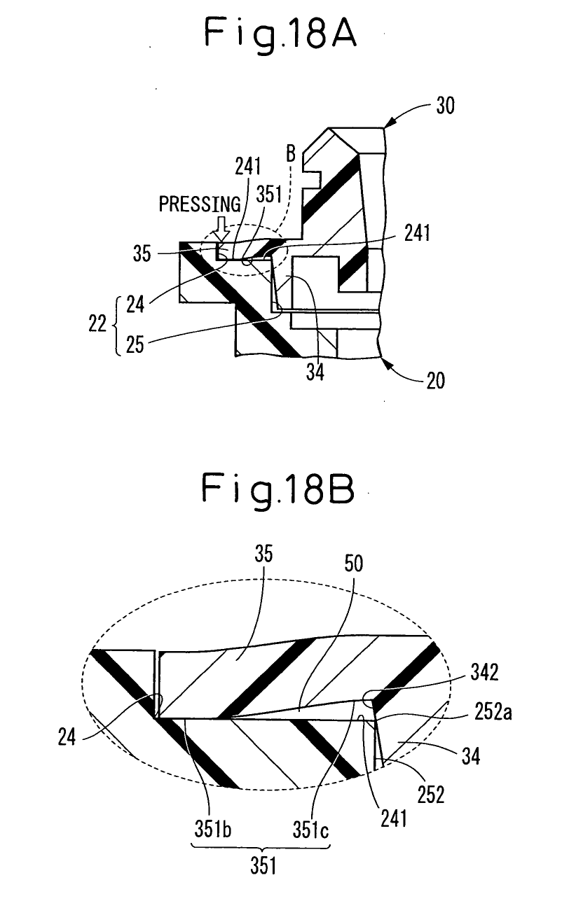

As shown in FIGS. 17A and 17B, at step S3, the engagement rib 34 is press-fitted into the smaller hole section 25 to press the side surface 342 of the engagement rib 34 onto a corner 252a of the side wall surface 252 forming the opening 251 in the smaller hole section 25. Thereby, the engagement plate 35 is fitted into the larger hole section 24 while maintaining a gap 44 between the plate surface 351 and the bottom wall surface 241 of the larger hole section 24. Further, at step S3, by pushing the outer circumference of the engagement plate 35 toward the bottom wall surface 241 as shown in FIGS. 18A and 18B, the outer circumferential portion 351b of the plate surface 351 apart from the engagement rib 34 is brought into press-contact with the bottom wall surface 241. Thus, the closed space 50 encircled by an inner circumferential portion 351c of the plate surface 351, the side surface 342 of the engagement rib 34, and the bottom wall surface 241 of the larger hole section 24 annularly extends in the circumferential direction of the larger hole section 24 in the engagement boundary between the engagement plate 35 and the larger hole section 24.

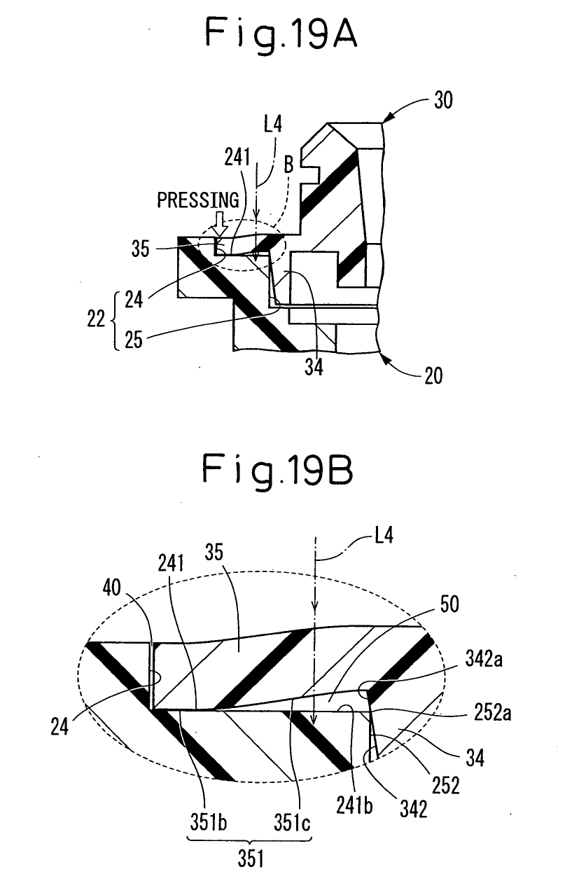

Further, as shown in FIGS. 19A and 19B, at step S4, the laser beam is irradiated while bringing the outer circumferential portion 351b of the plate surface 351 into press-contact with the bottom wall surface 241 by the pressure of the engagement plate 35. At this time, the laser beam is irradiated along an irradiating path L4 from the cap body 30 side while passing through the closed space 50 in the vertical direction of the bottom wall surface 241 to the main body 20 so that the laser beam passes all of the extending-directional areas of the closed space 50 approximately at the same time. The irradiated laser beam passes the laser beam-transparent cap body 30 and absorbed in an inner circumferential portion 241b of the bottom wall surface 241 in the larger hole section 24 of the laser beam-absorbent main body 20 exposed to the closed space 50. The inner circumferential portion 241b of the bottom wall surface 241 absorbing the laser beam is molten and the molten resin flows into the closed space 50 and is sealed therein. The molten resin sealed in the closed space 50 is brought into contact with the inner circumferential portion 351c of the plate surface 351 in the engagement plate 35 exposed to the closed space 50 and a portion 342a of the side surface 342 in the engagement rib 34 exposed to the closed space 50, and melts resin forming the contact portions. In such a manner, the molten resins flowing out from the main body 20 and the cap body 30 are mixed with each other and the resin mixture is cooled and solidified while being compressed by the pressure of the engagement plate 35, whereby the main body 20 and the cap body 30 are fixed to each other via the solidified resin mixture.

According to the fourth embodiment of the inventive method described above, as the molten resin flowing out from the main body 20 irradiated with the laser beam is sealed in the closed space 50, it is possible to restrict the generation of burrs caused by the resin flowing along the clearance 40 in the engagement boundary (see FIG. 19B). In addition, as the molten resin sealed in the closed space 50 is compressed by the pressure of the engagement plate 35, it is possible to significantly reduce the generation of voids.

(Fifth Embodiment)

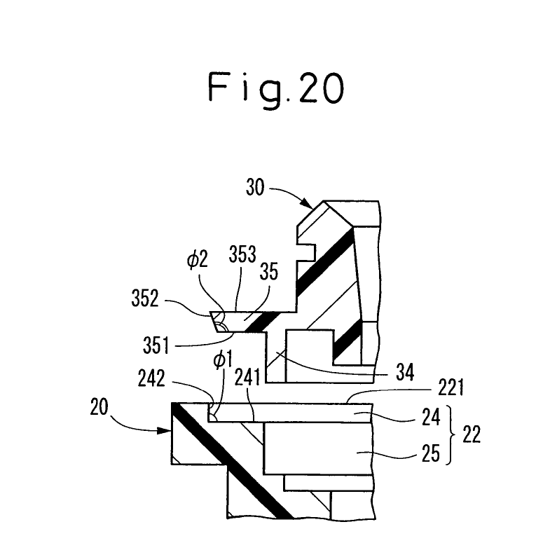

A fifth embodiment of the inventive method for manufacturing a magnetic valve 10 is illustrated in FIGS. 20 to 22B, wherein substantially the same elements as in the first embodiment are indicated by the same reference numerals.

In the fifth embodiment of the manufacturing method, the laser beam-transparent main body 20 is molded with resin at step S1, and the laser beam-absorbent cap body 30 is molded with resin at step S2.

As shown in FIG. 20, the ribs 26 and 27 are not formed at step S1. Instead, at step S1, the main body 20 is molded so that an angle φ1 defined by the bottom wall surface 241 and the side wall surface 242 of the larger hole section 24 becomes approximately a right angle in the cross-section, for example, shown in FIG. 20 taken along a plane orthogonal to the bottom wall surface 241 of the larger hole section 24. Further, at step S2, the cap body 30 is molded so that a supplement φ2 of an angle defined by the plate surface 351 and the side surface 352 becomes obtuse in the cross-section, for example, shown in FIG. 20 taken along a plane orthogonal to the plate surface 351 of the engagement plate 35. By such determination of the angles φ1 and φ2, in the engagement plate 35, the plate surface 351 is smaller than the opening 221 of the larger hole section 24, while the plate surface 353 opposite to the plate surface 351 is larger than the opening 221.

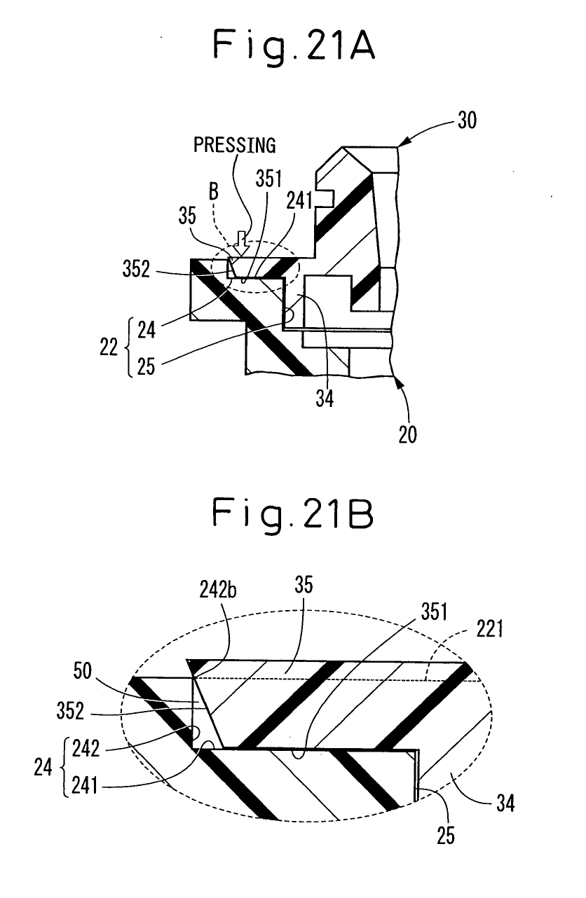

Also, as shown in FIGS. 21A and 21B, at step S3, the engagement rib 34 and the engagement plate 35 of the cap body 30 are fitted into the smaller hole section 25 and the larger hole section 24 of the inner hole 22 in the main body, respectively, and the engagement plate 35 is pushed toward the bottom wall surface 241 of the larger hole section 24. By the pressure of the engagement plate 35, the plate surface 351 of the engagement plate 35 is brought into press-contact with the bottom wall surface 241 of the larger hole section 24, and the side surface 352 of the engagement plate 35 is brought into press-contact with a corner 242b of the side wall surface 242 forming the opening 221 at a position apart from the bottom wall surface 241 in the larger hole section 24. As a result, in the engagement boundary between the engagement plate 35 and the larger hole section 24, the closed space 50 encircled by the bottom wall surface 241 and the side wall surface 242 of the larger hole section 24 and the side surface 352 of the engagement plate 35 annularly extends in the circumferential direction of the larger hole section 24.

In this embodiment, the larger hole section 24 of the inner hole 22 corresponds to the engagement hole.

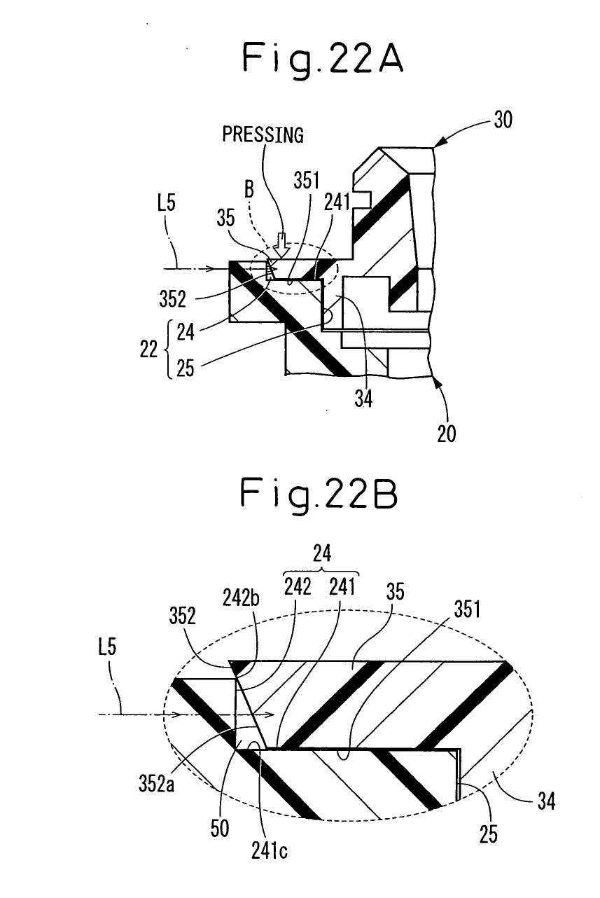

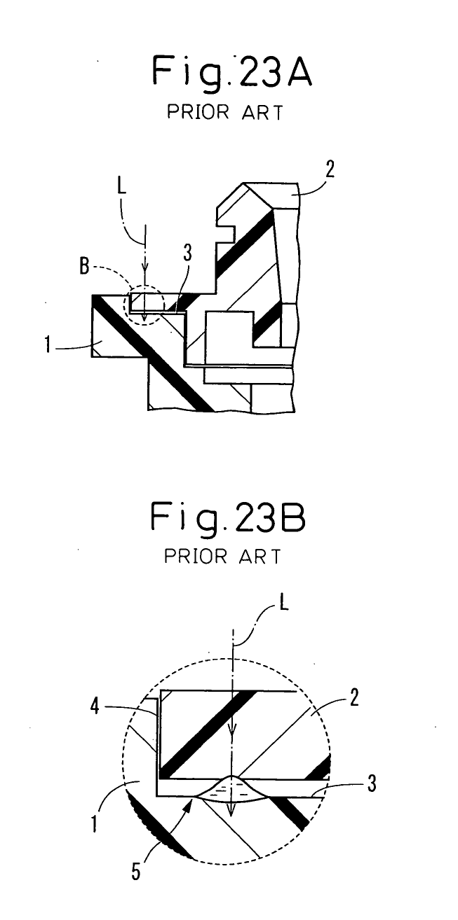

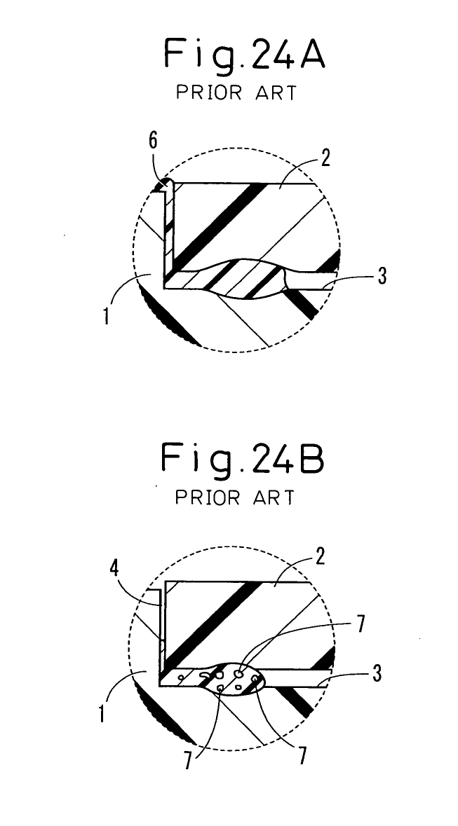

As shown in FIGS. 22A and 22B, at step S4, the laser beam is irradiated while bringing the plate surface 351 and the side surface 352 into press-contact with the bottom wall surface 241 and the corner 242b of the side wall surface 242, respectively, by the pressure of the engagement plate 35. At this time, a point in the closed space 50 through which the laser beam passes is sequentially shifted in the extending direction of the closed space 50 along an irradiating path L5 passing through the closed space 50 in the direction of the orthogonal line of the side wall surface 242 from the main body 20 side. The irradiated laser beam passes through the laser beam-transparent main body 20, and is absorbed in the portion 352a of the side surface 252 in the laser beam-absorbent cap body 30 exposed to the closed space 50. The portion 352a absorbing the laser beam is melted and the molten resin flows into the closed space 50 and is sealed therein. The molten resin sealed in the closed space 50 is brought into contact with the side wall surface 242 and the outer circumferential portion 241c of the bottom wall surface 241 in the larger hole section 24 exposed to the closed space 50, and melts resin forming the contact portions. In such a manner, the molten resins flowing out from the main body 20 and the cap body 30 are mixed with each other and the resin mixture is cooled and solidified while being compressed by the pressure of the engagement plate 35, whereby the main body 20 and the cap body 30 are fixed to each other via the solidified resin mixture.

According to the fifth embodiment of the inventive method described above, as the molten resin flowing out from the cap body 30 irradiated with the laser beam is sealed in the closed space 50, it is possible to restrict the generation of burrs caused by the molten resin swollen from the engagement boundary. In addition, as the molten resin sealed in the closed space 50 is compressed by the pressure of the engagement plate 35, it is possible to significantly reduce the generation of voids.

In the above-mentioned embodiments, after the main body 20 has been molded with resin as a first mold component at step S1, the cap body 30 is molded with resin as a second mold component at step S2. Alternatively, after the cap body 30 has been molded with resin, the main body 20 may be molded with resin, or the main body 20 and the cap body 30 may be molded with resin substantially at the same time.

According to the first, second and fourth embodiments, the laser beam-absorbent main body 20 and the laser beam-transparent cap body 30 are molded with resin. Contrarily, in the first, second and fourth embodiments, the laser beam-transparent main body 20 and the laser beam-absorbent cap body 30 may be molded with resin. In such a case, the irradiating paths L1, L2 and L4 for irradiating the laser beam are formed to pass through the closed space 50 from the main body 20 side to the cap body 30.

According to the first, second and fourth embodiments, the laser beam is irradiated to pass all areas of the closed space 50 as seen in the extending direction substantially at the same time. However, according to the third and fifth embodiments, the laser beam is irradiated so that a point in the closed space 50 through which the laser beam passes is sequentially shifted in the extending direction of the closed space 50. Alternatively, in the first, second and fourth embodiments, the laser beam may be irradiated so that the point in the closed space 50 is sequentially shifted in the extending direction of the closed space 50, and in the third and fifth embodiments, the beam is irradiated to pass all areas of the closed space 50 substantially at the same time.

Further, while the present invention is applied to the production of a magnetic valve 10 in which the cap body 30 is fitted into the inner hole 22 of the main body 20 in the above-mentioned embodiments, the present invention may be applied to the production of various resinous products in which a resin-mold component is fitted into an engagement hole of another resin-mold component.

While the invention has been described by reference to specific embodiments chosen for the purpose of illustration, it should be apparent that numerous modifications could be made thereto by those skilled in the art without departing from the basic concept and scope of the invention.

What is claimed is:

1. A method for manufacturing a resinous product formed of a first mold component and a second mold component fitted into an engagement hole of the first mold component, comprising
a molding process for molding a laser beam-transparent mold component, which is one of the first and second mold components, and a laser beam-absorbent mold component, which is the other of the first and second mold components, respectively, with resin,
an engagement process for fitting the second mold component into an engagement hole formed in the first mold component during the molding process to form an annular closed space extending in the circumferential direction of the engagement hole in the engagement boundary between the engagement hole and the second mold component, and
a welding process for irradiating the laser beam along a path penetrating one of the first and second mold components and reaching the other of the first and second mold components while passing through the closed space so that the first and second mold components are welded and fixed with each other.

2. A method for manufacturing a resinous product as defined by claim 1, wherein two annular ribs formed at a distance between the both are provided in an inner wall of the engagement hole during the molding process, and
the closed space is formed by bringing an outer wall surface of the second mold component into press-contact with tip end surfaces of the ribs during the engagement process.

3. A method for manufacturing a resinous product as defined by claim 2, wherein the laser beam is irradiated while pushing the second mold component in the direction opposite to the projecting direction of the ribs during the welding process.

4. A method for manufacturing a resinous product as defined by claim 1, wherein two annular ribs formed at a distance between the both are provided in an outer wall of the second mold component during the molding process, and
the closed space is formed by bringing tip end surfaces of the ribs into press-contact with an outer wall surface of the second mold component during the engagement process.

5. A method for manufacturing a resinous product as defined by claim 4, wherein the laser beam is irradiated while pushing the second mold component in the projecting direction of the ribs during the welding process.

6. A method for manufacturing a resinous product as defined by claim 1, wherein a larger hole section of a bottomed hole shape and a smaller hole section opened to a bottom wall surface of the larger hole section are formed in the first mold component, and an engagement plate and an engagement rib projected from a plate surface of the engagement plate are formed in the second mold component during the molding process, and
the closed space is formed by press-fitting the engagement rib into the smaller hole section and by bringing a portion of the plate surface of the engagement plate apart from the engagement rib into press-contact with a bottom wall surface of the larger hole section during the engagement process.

7. A method for manufacturing a resinous product as defined by claim 1, wherein the engagement hole of a bottomed hole shape is formed in the first mold component and the engagement plate is formed in the second mold component during the molding process, and
the closed space is formed by bringing a plate surface of the engagement plate into press-contact with the bottom wall surface of the engagement hole, and bringing a side surface of the engagement plate into press-contact with a portion of the side wall surface of the engagement hole apart from the bottom wall surface during the engagement process.

8. A method for manufacturing a resinous product as defined by claim 1, wherein the laser beam is irradiated during the welding process so that the laser beam passes through all areas of the closed space as seen in the extending direction of the closed space substantially at the same time.

9. A method for manufacturing a resinous product as defined by claim 1, wherein the laser beam is irradiated during the welding process so that a point in the closed space through which the laser beam passes is sequentially shifted in the extending direction of the closed space.

10. A resinous product manufactured by the method defined by claim 1.
